(19) United States
(12) Patent Application Publication
(10) Pub. No.: US 2023/0358558 A1
(43) Pub. Date: Nov. 9, 2023

(54) METHOD, APPARATUS, AND SYSTEM FOR DETERMINING A LANE MARKING CONFUSION INDEX BASED ON LANE CONFUSION EVENT DETECTIONS

(71) Applicant: HERE Global B.V., Eindhoven (NL)

(72) Inventors: Jerome BEAUREPAIRE, Nantes (FR); Leon STENNETH, Chicago, IL (US); Jeremy Michael YOUNG, Chicago, IL (US)

(21) Appl. No.: 17/735,733

(22) Filed: May 3, 2022

(51) Int. Cl. G01C 21/00; G06V 20/56; G01C 21/36

(52) U.S. Cl. CPC G01C 21/3815; G06V 20/588; G01C 21/3658; G01C 21/3841; G01C 21/3856

(57) ABSTRACT

An approach is provided for determining a lane marking confusion index based on lane confusion event detections. The approach, for example, involves detecting, by at least one processor, a number of instances of a lane confusion event associated with a location in a road network. The lane confusion event indicates presence of temporary lane markings in addition to standard lane markings at the location. The approach also involves determining, by the at least on processor, a lane marking confusion index for the location based on the detected number of instances of the lane confusion event in association with the location. The approach further involves storing, by the at least one processor, the lane marking confusion index as a map attribute of the location in a geographic database.

### BACKGROUND

Providing environmental awareness for vehicle safety is one area of development for mapping and navigation services. Road surface markings provide guidance and safety to drivers and vehicles. Nevertheless, improper additions and changes in the markings on a road segment can cause confusion and danger. For instance, vehicles with lane keeping assistant (LKA) may ignore work zone detour lane markings and continue driving in the same lane, which can cause accidents such as collisions into physical dividers. As another instance, after road work, the temporary lane markings may remain visible and interfere with the correct lane markings. As such, the vehicles with LKA follow the temporary lane markings and run into accidents. Some navigation applications (e.g., Waze) allow users to report map issues (e.g., a general map error, incorrect turn, incorrect address, speed limit, incorrect route, missing roundabout or missing road), gas prices and types, closure, hazard (e.g., on road, shoulder, weather (including unplowed road, fog, hail, flood, ice), traffic jam, police, crash, place, or even adding a missing road. However, there is no mechanism for user-reported or automatically detected confusing lane markings. Accordingly, mapping and navigation service providers face significant technical challenges to enable reporting of confusing lane markings.

### SOME EXAMPLE EMBODIMENTS

Therefore, there is a need for automatically generating map data that can indicate where and when to encounter confusing road markings, for example, via determining a lane marking confusion index based on lane marking confusion event detections.

According to example embodiment(s), a method comprises detecting, by at least one processor, a number of instances of a lane confusion event associated with a location in a road network. The lane confusion event indicates presence of temporary lane markings in addition to standard lane markings at the location. The method also comprises determining, by the at least on processor, a lane marking confusion index for the location based on the detected number of instances of the lane confusion event in association with the location. The method further comprises storing, by the at least one processor, the lane marking confusion index as a map attribute of the location in a geographic database.

According to another embodiment, an apparatus comprises at least one processor, and at least one memory including computer program code for one or more computer programs, the at least one memory and the computer program code configured to, with the at least one processor, cause, at least in part, the apparatus to detect a number of instances of a lane confusion event associated with a location in a road network. The lane confusion event indicates presence of temporary lane markings in addition to standard lane markings at the location. The apparatus is also caused to determine a lane marking confusion index for the location based on the detected number of instances of the lane confusion event in association with the location. The apparatus is further caused to store the lane marking confusion index as a map attribute of the location in a geographic database.

According to another embodiment, a computer program product may be provided. For example, a computer program product comprising instructions which, when the program is executed by a computer, cause the computer to detect a number of instances of a lane confusion event associated with a location in a road network. The lane confusion event indicates presence of temporary lane markings in addition to standard lane markings at the location. The computer is also caused to determine a lane marking confusion index for the location based on the detected number of instances of the lane confusion event in association with the location. The computer is further caused to store the lane marking confusion index as a map attribute of the location in a geographic database.

According to another embodiment, a non-transitory computer-readable storage medium carries one or more sequences of one or more instructions which, when executed by one or more processors, cause, at least in part, an apparatus to detect a number of instances of a lane confusion event associated with a location in a road network. The lane confusion event indicates presence of temporary lane markings in addition to standard lane markings at the location. The apparatus is also caused to determine a lane marking confusion index for the location based on the detected number of instances of the lane confusion event in association with the location. The apparatus is further caused to store the lane marking confusion index as a map attribute of the location in a geographic database.

According to another embodiment, an apparatus comprises means for detecting a number of instances of a lane confusion event associated with a location in a road network. The lane confusion event indicates presence of temporary lane markings in addition to standard lane markings at the location. The apparatus also comprises means for determining a lane marking confusion index for the location based on the detected number of instances of the lane confusion event in association with the location. The apparatus further comprises means for storing the lane marking confusion index as a map attribute of the location in a geographic database.

In addition, for various example embodiments described herein, the following is applicable: a computer program product may be provided. For example, a computer program product comprising instructions which, when the program is executed by a computer, cause the computer to perform any one or any combination of methods (or processes) disclosed.

According to another embodiment, an apparatus comprises means for retrieving sensor data collected from one or more devices within proximity of a road lane. The sensor data is geotagged with location data. The method also comprises processing the geotagged sensor data to identify an observed obstruction to bicycle traffic on the road lane. The method further comprises map-matching the location data to a road lane segment of a geographic database. The method further comprises computing the lane marking confusion index for the road lane segment based on the obstruction. The lane marking confusion index, for instance, indicates a probability of encountering any obstruction on the road lane segment. The method further comprises storing the lane marking confusion index as an attribute of the road lane segment in the geographic database.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining a lane marking confusion index based on lane confusion event detections, according to example embodiment(s);

FIG. 2 is a diagram illustration an example representation of lane marking confusion index over an extend of a road lane, according to example embodiment(s);

FIG. 3 is a diagram of the components of a mapping platform capable of determining a lane marking confusion index based on lane confusion event detections, according to example embodiment(s);

FIG. 4 is a flowchart of a process for determining a lane marking confusion index based on lane confusion event detections, according to example embodiment(s);

FIGS. 5A-5D are example confusing road features on different roads, according to example embodiment(s);

FIG. 6 is a diagram of an example user interface for navigation routing based on a lane marking confusion index, according to example embodiment(s);

FIG. 7 is a diagram of a geographic database, according to example embodiment(s);

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset or vehicle or part thereof) that can be used to implement an embodiment.

### DESCRIPTION OF SOME EMBODIMENTS

Examples of a method, apparatus, and computer program for determining a lane marking confusion index based on lane confusion event detections are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

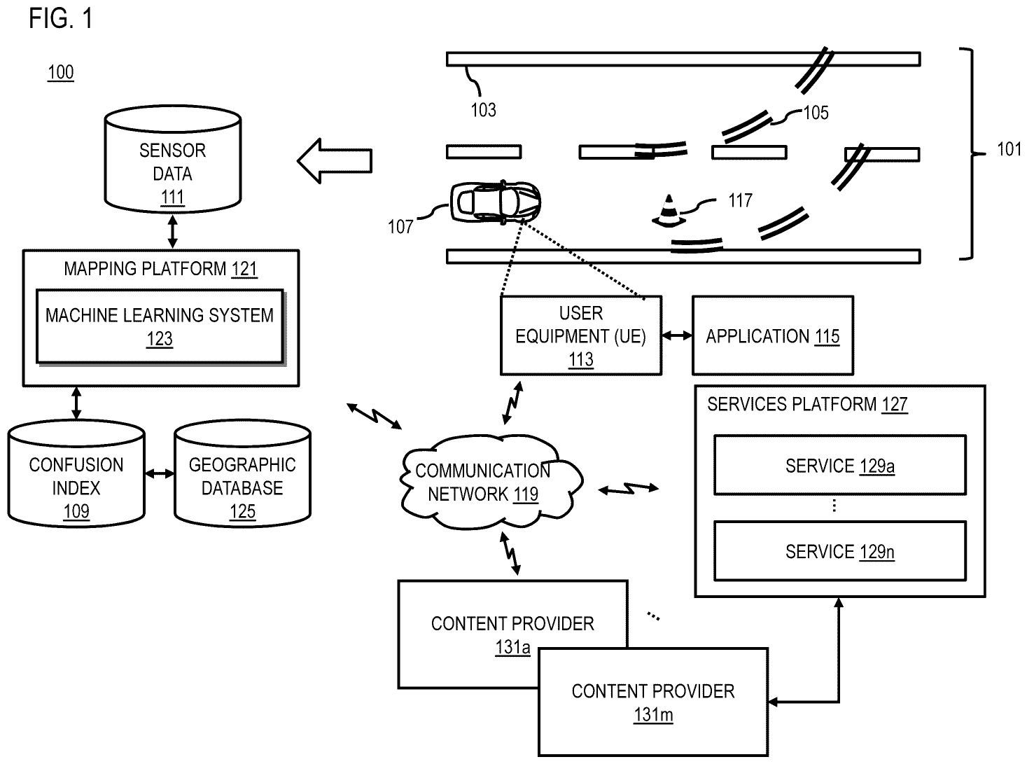

FIG. 1 is a diagram of a system capable of determining a lane marking confusion index based on lane confusion event detections, according to example embodiment(s). Many roads (e.g., road 101) defined by lane markings 103 support vehicular traffic thereon to increase safety. Nonetheless, road users face potential dangers from various confusing lane markings 105 (e.g., created on the road 101 for a work zone) that can confuse drivers and/or vehicles 107. These confusing lane markings 105, however, are generally transient and can be recognized by human eyes. Accordingly, it can be labor intensive to detect and report the confusing lane markings 105. Therefore, mapping and navigation service providers face significant technical challenges to automatically generate information on the presence of confusing lane markings 105 on the road 101.

To address these technical challenges, the system 100 of FIG. 1 introduces a capability to generate a lane marking confusion index 109 based on sensor data 111 (e.g., real-time and/or historical sensor data reports) that is associated with various segments of the road lanes. The sensor data 111 can be image data, probe data, and/or other equivalent types of data collected from one or more sensors of vehicles 107 and/or user equipment (UE) devices 113 affixed to the vehicles 107 executing applications 115) traversing the road 101 that includes the lane markings 103. Although various embodiments are described with respect to confusing lane markings 105, it is contemplated that the approach described herein may be used with other confusing road features, such as confusing road signs (e.g., a misplaced traffic cone 117).

The collected sensor data 111 is then reported or otherwise transmitted (e.g., over a communication network 119) to a mapping platform 121 for processing. The sensor data 111 can be processed (e.g., using a machine learning based feature detector(s) such as a machine learning system 123) to detect instances in which the confusing lane markings 105 and/or lane confusion event(s) are observed on the road 101.

In one embodiment, the lane marking confusion index 109 is calculated based on a number of instances of observed/detected lane confusion event(s). For instance, a lane confusion event can be an accident “avoidance” maneuver by the driver to correct the course of the vehicle 107 because the vehicle 107 follows improper lane markings (e.g., via lane keeping assistant). In another embodiment, the lane marking confusion index 109 can be a metric that represents the probability that lane confusion event(s) will occur in the presence of the confusing lane markings 105 on a given lane segment (e.g., each meter or other designated distance interval) of the road 101. For instance, the system 100 can divide the number of observed/detected lane confusion events by the total number of vehicles travelling on the road 101 as the index 109.

For example, a lane marking confusion index 109 can be computed for each meter or distance interval of a road lane (or any other designated portion of the road lane) to map the lane marking confusion index 109 over the extent of the road lane. In one embodiment, the lane marking confusion index 109 can also be calculated over designated time epochs (e.g., each 15-minute time epoch over an entire day). The lane marking confusion index 109 can then be calculated for each lane segment (e.g., 1-meter segment or other designated distance) for each time epoch. In this way, the probability of observing any confusing lane marking(s) and/or lane confusion event(s) at each lane segment of the road 101 can be determined. Alternatively or concurrently, the system 100 can apply the machine learning system 123 to learn the conditions leading to such avoidance maneuvers and predict instances of lane confusion events at locations based on map data attributes, vehicle sensors reading, maneuvers, etc. For instance, when the traffic cones/signs were removed earlier than the temporary lane markings, a machine learning model can predict the work zone is being removed. The machine learning model can use map attributes (e.g., a number of lanes, speed limits, construction signs, lane marking geometry, and color (for example, unusual curvature means detouring), historical lane markings, etc.) to determine which lane line is populating via time as the new lane for vehicles to take.

The system 100 can report the lane confusion events (e.g., accident avoidance vehicle maneuvers) and/or the index 109, for example, after linking such maneuvers to a possible lane marking issue in a road work area, to a map database (e.g., a geographic database 125), location-based service(s) (e.g., traffic reporting services), etc.

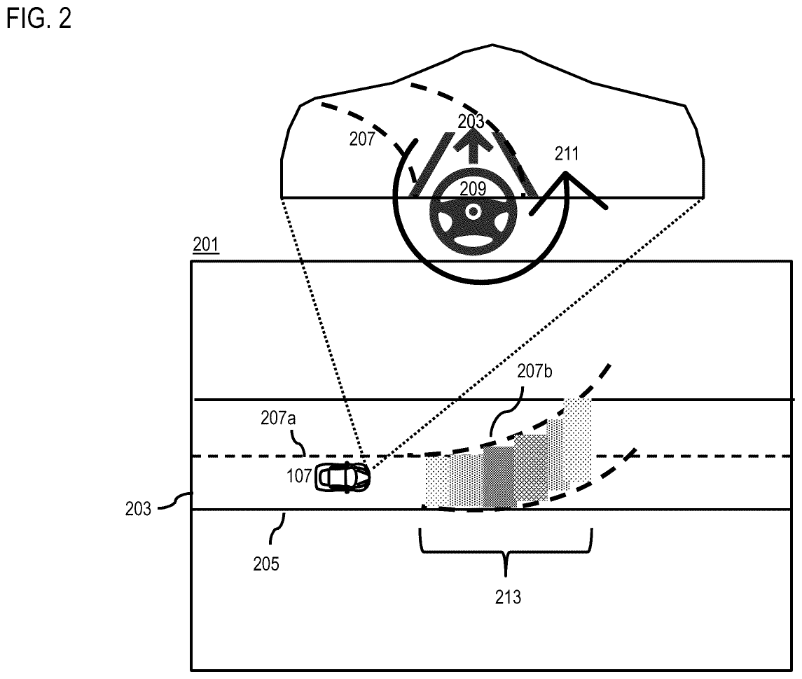

FIG. 2 is a diagram illustration an example representation 201 (e.g., a mapping user interface) of a lane marking confusion index 109 over an extent of a road lane, according to example embodiment(s). In the example of FIG. 2, the mapping platform 121 has collected sensor data 111 (e.g., image data) over a designated time period that depicts a road lane 203 of a road 205. The sensor data 111 is processed to determine instances of when/where lane confusion event(s) is detected along discrete segments (e.g., 1-meter segments) of the road lane 203. For instance, the lane confusion event(s) can include a driver manually overwriting a self-driving system to follow a new lane marking, applying brake to follow the new lane marking, etc.

Then, a lane marking confusion index 109 is calculated based on the instance(s) of lane confusion event(s) map-matched to a given location/segment. For example, the lane marking confusion index 109 can be calculated based on the number of lane confusion events per location on the road lane 203. As another example, the lane marking confusion index 109 can be calculated based on a probability of observing the lane confusion event(s) at that location on the road lane 203. The probability, for instance, can range from 0.0 (e.g., 0% probability of encountering an obstacle) to 1.0 (100% probability of encountering an obstacle) and be based on the frequency at which the instances of lane confusion event(s) (e.g., as determined from the senor data 111) is observed at the given segment. The individual 1-meter segments of the road lane are visualized based the value of their respective road lane disruption indices 109. For example, index values below a minimum threshold (e.g., 25%) are shown as white/blank, above a maximum threshold (e.g., 85%) are shown as black, and in-between with higher values shaded darker. As another example, when detecting index values above a threshold (e.g., 45%), the system 100 can alert the driver to pay attention to potential confusing lane markings.

In FIG. 2, the respective road lane disruption indices 109 associated with confusing lane markings 207b at locations therein are marked with shades in portion with a respective number of lane confusion event instances, i.e., the darker the shade, the higher the instance numbers. In this example, the accident “avoidance” maneuver is turning a steering wheel 209 in a direction 211 (e.g., counterclockwise) to get on a detour lane marked by the confusing lane markings 207b, instead of keeping lane marking 207a of the road lane 203. In a portion 213 of the road 205, each 1-meter segment therein is shaded darker in proportion to their index values.

The system 100 can compute a contextual lane marking confusion index based on number of lane confusion events. In addition, different lane confusion events can be weighted differently with different weight factors. For instance, the lane confusion events can include vehicles coming from an opposite direction, a detected lane number different from a total lane number of the road based on map data (e.g., detected eight lanes on a two-lane road), recognizing objects ahead above the horizon (based on sensor data e.g., Lidar), etc. The lane marking confusion index can be also based on other context, such as weather, traffic, vehicle models (e.g., different sensor capabilities, machine learning models, etc.), etc.

Therefore, the system 100 can train machine learning models to recognize factors/conditions (e.g., features of the environments, movements of nearby vehicles, etc.) that lead to lane confusion events (e.g., driving (path correction) maneuvers due to lane marking confusion) based on video analysis, probe data, map features, historical road feature progressing information, etc., so to determine lane marking confusion indices, thereby generating navigation alerts regarding confusing road features (e.g., lane markings) and improving safety.

In summary, the various embodiments described herein disclose a method, apparatus, and system to compute a lane marking confusion index 109 by leveraging sensor data 111 (e.g., light detection and ranging (LiDAR) sensors, vehicle's camera feeds, and/or equivalent). By using a lane marking confusion index 109, the system 100 enables drivers and/or vehicles 107 to be routed on the safest road lanes among other applications and/or services. For example, it is contemplated that the lane marking confusion index 109 can be use directly or as attributes of road lanes 203 stored in the geographic database 125 by any service or application. Examples of the services and/or applications include but are not limited to a services platform 127, one or more services 129a-129n (also collectively referred to as services 129) of the services platform 127, one or more content providers 131a-131m (also collectively referred to as content providers 131), and/or the like.

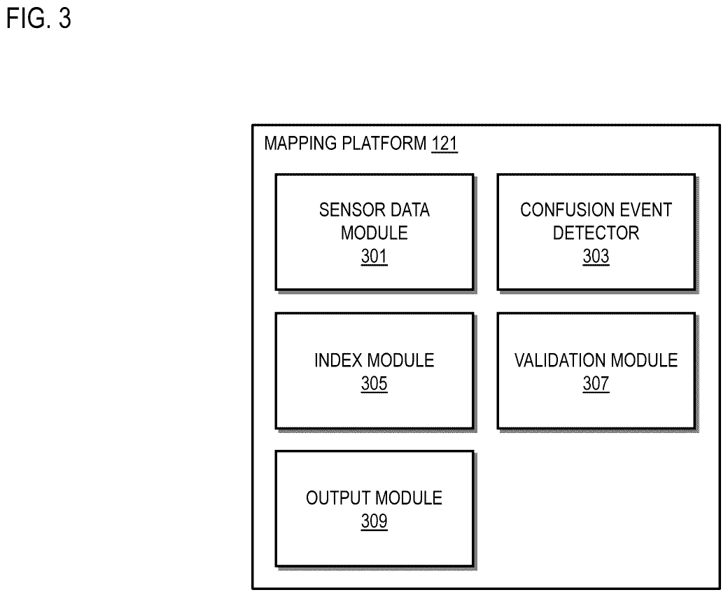

FIG. 3 is a diagram of the components of mapping platform 121 capable of determining a lane marking confusion index based on lane confusion event detections, according to example embodiment(s). In one embodiment, as shown in FIG. 2, the mapping platform 121 of the system 100 includes one or more components for determining a lane marking confusion index 109 according to the various embodiments described herein. It is contemplated that the functions of the components of the mapping platform 121 may be combined or performed by other components of equivalent functionality. As shown, in one embodiment, the mapping platform 121 includes a sensor data module 301, a confusion event detector 303, an index module 305, a validation module 307, and an output module 309. The above presented modules and components of the mapping platform 121 can be implemented in hardware, firmware, software, or a combination thereof. Though depicted as a separate entity in FIG. 1, it is contemplated that the mapping platform 121 may be implemented as a module of any of the components of the system 100 (e.g., a component of the services platform 127, services 129, content providers 131, vehicles 107, UEs 113, applications 115, and/or the like). In another embodiment, one or more of the modules 301-309 may be implemented as a cloud-based service, local service, native application, or combination thereof. The functions of the mapping platform 121 and modules 301-309 are discussed with respect to figures below.

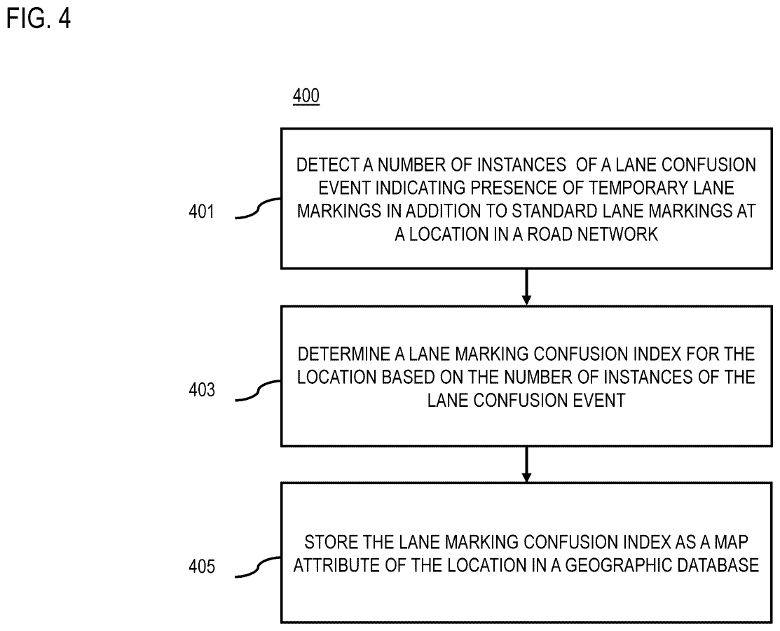

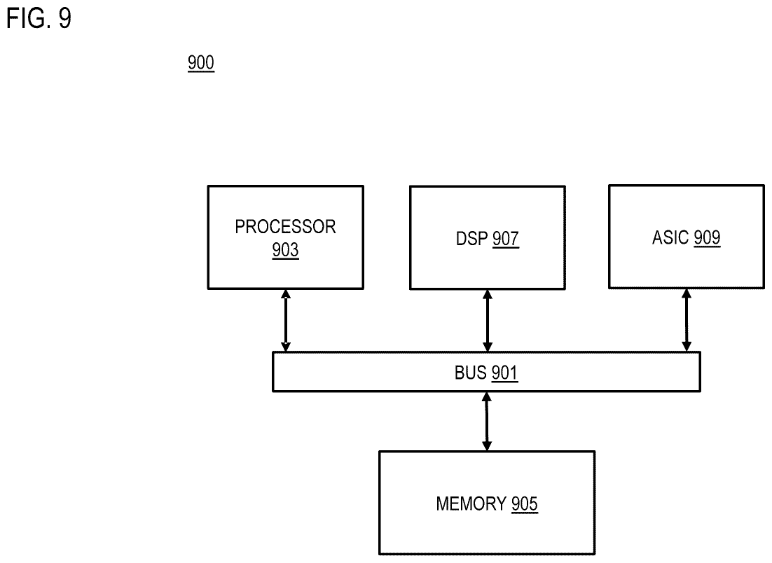

FIG. 4 is a flowchart of a process for determining a lane marking confusion index based on lane confusion event detections, according to example embodiment(s). In various embodiments, the mapping platform 121 and/or any of the modules 301-309 may perform one or more portions of the process 400 and may be implemented in, for instance, a chip set including a processor and a memory as shown in FIG. 9. As such, the mapping platform 121 and/or any of the modules 301-309 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

In one embodiment, for example, in step 401, the confusion event detector 303 can detect a number of instances of a lane confusion event associated with a location in a road network. In one embodiment, the lane confusion event can indicates presence of temporary lane markings in addition to standard lane markings at the location. By way of example, the sensor data module 301 can retrieve sensor data 111 collected from one or more devices (e.g., devices in the vehicle 107 or in nearby vehicles, in UEs 113, infrastructure sensors (e.g., inground traffic loop sensors, traffic cameras, traffic lights, traffic signals, digital signage, etc.), etc. within proximity of a road lane, and the sensor data 111 can be geotagged with location data (e.g., geocoordinates) and/or a timestamp (e.g., date and time) indicating where and when the sensor data 111 was collected. By way of example, the sensor data 111 includes image data captured by a camera sensor, a light detection and ranging (LiDAR) sensor, infrared sensors of the vehicle 107, probe data determined using a location sensor, etc.

In one embedment, the vehicle 107 can use these sensors when driving on the road 101 including a road lane. For example, the vehicle 107 can query the geographic database 125 to determine whether the current road 101 on which the vehicle 107 is driving has a road lane. In addition or alternatively, the vehicle 107 can use its onboard sensors to detect the road lane (e.g., by using a feature detector on captured imagery to detect lane markings indicative of a road lane). On determining the presence of a road lane, the vehicle 107 can begin collecting sensor data 111 (e.g., image data, LiDAR data, or equivalent) for detection of lane markings that may be present in the road lane. In one embodiment, the vehicle 107 can also receive sensor data 111 collected by other nearby vehicles and/or nearby infrastructure sensors via v2v, v2x, or any other equivalent communication protocol (e.g., available over the communication network 119. The sensor data 111 from these other vehicles, devices, and/or sensors can be included in the sensor data 111 transmitted to or otherwise retrieved by the sensor data module 301.

For instance, the sensor data module 301 can retrieve sensor data indicative of (lane marking) confusion events occurring on the road 205 in FIG. 2 for the confusing event detector 303 to detect the occurrence of such (lane marking) confusion events. As used herein, confusion event(s) refers to any situation where there is a question/confusion regarding which lane marking to follow when there are multiple (e.g., at least partially overlapping) lane markings present For example, such question/confusion can lead to vehicle maneuver(s) not following lanes/roads correctly or any accident avoidance vehicle maneuver(s) by a human driver and/or artificial intelligence (e.g., vehicles with LKA, autonomous vehicle control system, lane keeping assistance, etc.) as triggered by confusing object(s), feature(s), condition(s), etc. associated with road feature(s) (e.g., lane marking(s)) that can affect the lane/path, safety, progress, and/or speed of the vehicle on the road lane. As described herein, lane confusion event(s) is used as an example for confusion event(s).

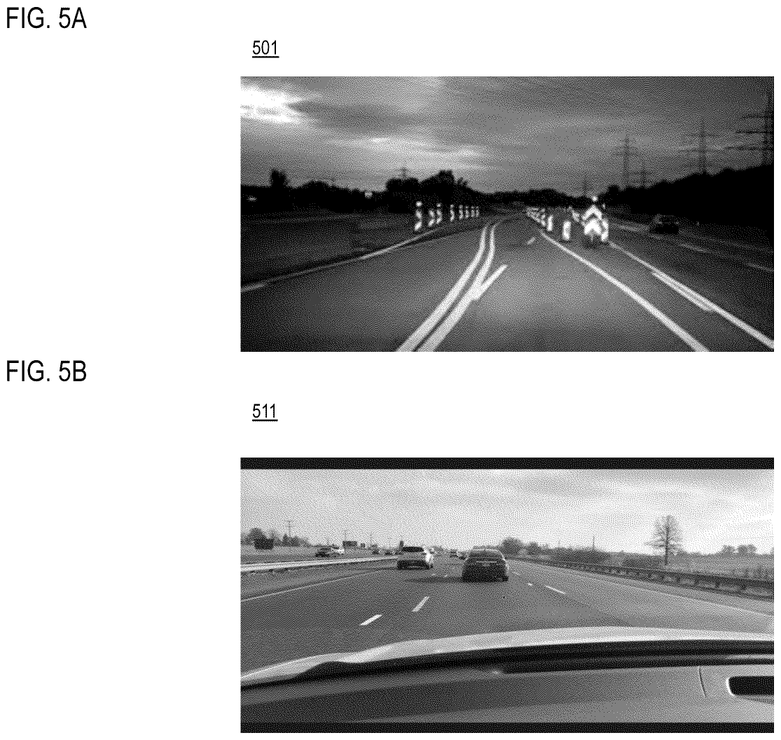

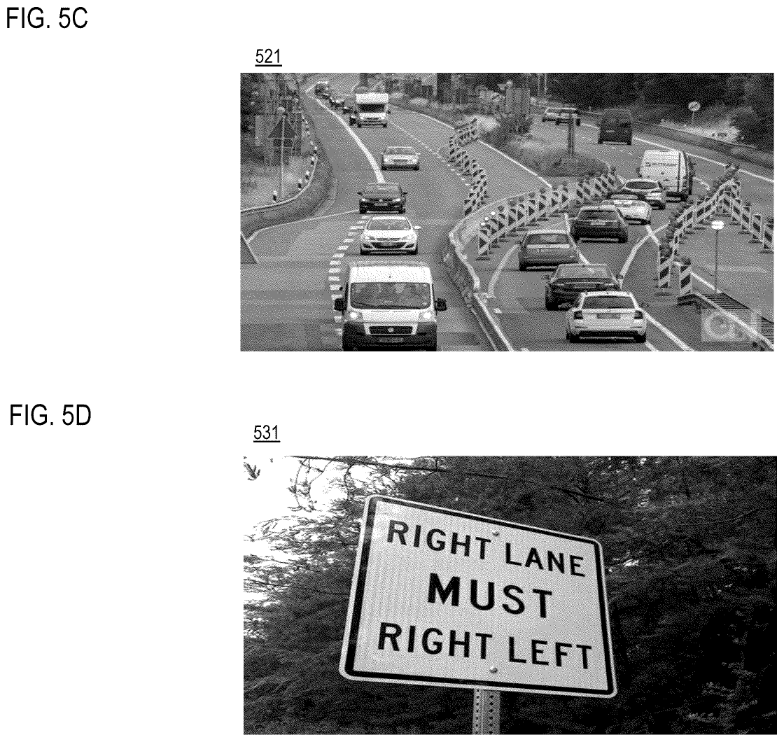

FIGS. 5A-5D are example confusing road features on different roads, according to example embodiment(s). FIG. 5A depicts an image 501 of confusing lane markings that include solid curved lane markings indicating a lane detour from the original straight broken lane markings, as well as high intensity reflective vertical signs along the solid curved lane markings. FIG. 5B depicts an image 511 of a new set of lane markings next to an out-of-date set of lane marking that are still visible thus confusing. FIG. 5C depicts an image 521 of another detouring scenario that is similar to the image 501 yet with vehicle traffic and cement dividers in addition to the lane markings and reflective vertical signs. FIG. 5D depicts an image 531 of a road sign that reads “Right lane must right left” that can confuse the vehicle 107. Such confusing road features can lead to confusion event(s). Other example confusing road features can include a confusing road marking line stopping at a traffic light (such that it is not clear where to stop), multiple road sign confusion (e.g., both new and old speed limits visible, “left turn only” and “straight ahead”, etc.), etc.

In one embodiment, detecting instances of the lane confusion event can comprise obtaining, from one or more vehicles (e.g., via a built-in device, the application 115 of the UE 113, a traffic platform/service, etc.) traveling through the location, one or more lane marking reports that each respectively indicates the lane confusion event. For instance, the one or more lane marking reports can indicate a presence of different lane marking colors/designs (e.g., FIG. 5A), a presence of overlapping/duplicating lane markings (e.g., FIG. 5B), or a combination thereof associated with the lane confusion event at the location. Referring back to FIG. 2, the LiDAR sensor can directly scan for lane markings 207a, 207b (e.g., based on reflectivity) when travelling on the road 205 where the vehicle path is described by a sequence of two or more location data points determined using a positioning sensor of the vehicle 107 or UE 113.

As other examples, the confusing lane marking(s) and/or lane confusion event(s) (while managing to avoid an accident from happening) can be “manual labelled” by users in reports, as they see or “experience” them. The users can simply use voice command(s) to be captured by a voice assistant (e.g., Alexa, Siri, etc.), to manually label the confusing lane marking(s) and/or lane confusion event(s) at a location. Concurrently or alternatively, the confusion event detector 303 can apply machine learning to identify and label the confusing lane marking(s) and/or lane confusion event(s). For instance, the confusion event detector 303 can work in conjunction with the machine learning system 123 to build a machine learning model for conditions leading to lane confusion events (e.g., accident avoidance vehicle maneuvers) based on map data attributes, sensor data 111, maneuvers data, and/or training data, so as to predict lane confusion event locations.

For instance, the confusion event detector 303 can recognize based on the sensor data 11 and map data a difference between correct marking(s) and incorrect marking(s) and prompt the user for confirmation that a lane confusion event has occurred to take construction re-route based on the new drive path and lane boundaries.

As another instance, the lane confusion event can be based on detecting a manual path correction over a lane keeping assist system at the location. For instance, a lane keeping assistant of the vehicle 107 can instruct the vehicle 107 to follow the lane markings 207a in FIG. 2, instead of following the confusing yet correct detour lane markings 207b. In this case, the driver of the vehicle 107 is forced to take over the vehicle 107 to drive on the detour lane defined by the lane markings 207b, i.e., a manual path correction.

As yet another instance, the lane confusion event indicates a presence of a correct travel lane (e.g., a lane currently intended by a transportation authority, a road work entity, a property owner, etc. associated with the location) defined by one of the temporary lane markings and the standard lane markings, and an incorrect travel lane defined by the other one of the temporary lane markings and the standard lane markings at the location. For example, the lane confusion event can indicate a presence of a construction zone (e.g., FIG. 5C), the correct travel lane defined by the temporary/detour lane markings, and the incorrect travel lane is defined by the standard lane markings at the location. As another example, the lane confusion event can indicate road remarking (e.g., FIG. 5B), the correct travel lane defined by the standard/new lane markings, and the incorrect travel lane is defined by the temporary/fading lane markings at the location.

In one embodiment, in step 403, the index module 305 can determine a lane marking confusion index (LMCI) for the location based on the detected number of instances of the lane confusion event in association with the location. For instance, the lane marking confusion index 109 can be computed per location based on the number of lane confusion events. In one embodiment, the LMCI for the location can increase as the number detected confusion events for the location increases. In other words, any increase in the number of detected lane confusion events (e.g., whether detecting different colors, path corrections, etc.) can lead to an increase in the LMCI. By way of example, the LMCI can increase where there are multiple different lane marking colors at a location. The different color lane markings can be captured by vehicle cameras. The more vehicles reporting different lane marking colors, the higher the LMCI. The calculation of the LMCI can be done in the cloud after receiving information from at least one vehicle. The lane marking confusion index can then be used to update a map.

In another embodiment, the lane marking confusion index 109 can be computed further based on the timestamps of the sensor data 111 to accurately compute time-dependent number of lane confusion events per location.

The detection of confusing lane marking(s) and/or lane confusion event(s) could be (at least partly) automated through video analysis and machine learning models built by the machine learning system 123. The machine learning models can be trained with input data which shows areas with confusing lane marking(s) and/or lane confusion event(s). the models could be trained to then detect more rapidly in the field. The models can predict the risk of facing confusing lane marking(s) and/or lane confusion event(s) when approaching areas with similar patterns (“Transfer Learning”), so as to answer: “Which set of lane markings (e.g., original lane vs temporary lane) to follow at a given time?”

In one embodiment, the machine learning system 123 selects respective factors such as a number of lanes, speed limits, construction signs, lane marking geometry, and color, historical lane markings, transport modes, traffic patterns, driving behaviors of nearby vehicles, weather, events, etc., to determine road feature confusion event for different scenarios in different regions (e.g., towns, city, suburbs, mountains, countries, etc.). In one embodiment, the machine learning system 123 can train the machine learning models to select or assign respective weights, correlations, relationships, etc. among the factors, to determine optimal thresholds for different scenarios. In one instance, the machine learning system 123 can continuously provide and/or update a machine learning model (e.g., a support vector machine (SVM), neural network, decision tree, etc.) of the machine learning system 123 during training using, for instance, supervised deep convolution networks or equivalents. In other words, the machine learning system 123 trains the machine learning models using the respective weights of the factors to most efficiently select optimal thresholds for different scenarios in different regions.

In another embodiment, the machine learning system 123 includes a neural network or other machine learning system to compare (e.g., iteratively) road features (e.g., using distance/width/length thresholds, offsets, etc.) to detect/predict lane confusion events on reported road segments. In one embodiment, the neural network of the machine learning system 123 is a traditional convolutional neural network which consists of multiple layers of collections of one or more neurons (which are configured to process a portion of an input data). In one embodiment, the machine learning system 123 also has connectivity or access over the communication network 109 to the geographic database 125 that can each store probe data, labeled or marked road features (e.g., historically expected confusion events and/or real-time actual observed confusion events on road segments), etc.

In one embodiment, the machine learning system 123 can improve the discussed road feature confusion event determining/predicting process using feedback loops based on, for example, user/vehicle behavior and/or feedback data (e.g., from vehicle users, traffic incident specialists, etc.). In one embodiment, the machine learning system 123 can improve a machine learning model for the road feature confusion event determining/predicting process using user/vehicle behavior and/or feedback data as training data. For example, the machine learning system 123 can analyze correctly identified road feature confusion event data, missed road feature confusion event data, etc. to determine the performance of the machine learning models. For instance, if a user asks “which marking should I follow? How much longer will be this way?, the machine learning model can generate recommendations based on historical average data or retrieve data from a road authority database. As another instance, if a user asks, “what happen here?, the machine learning model can generate a reply “Temporary line applied on 4/1 and painted line applied on 4/15.”

It is noted that the above calculation is provided by way of illustration as not as a limitation. It is contemplated that any statistical or mathematical process can be used to perform an equivalent calculation. For example, in one embodiment, the index module 305 can use the machine learning system 123 to determine the lane marking confusion index 109. The machine learning system 123, for instance, would take as an input all of the reported sensor data events linked to the lane confusion events of road lanes 203 and process the input using a trained machine learning model (e.g., a neural network). The output of the machine learning system 123 would be the predicted lane marking confusion index for a given time and/or location (e.g., road lane segment).

In addition to computing by road lane segments, the index module 305 can further compute the data according to time epoch. For example, a day can be divided into 15-minute time epochs, and the observed lane confusion events and total number or sensor data reports can then be computed by both road lane segment and time epoch. In this way, the index module 305 can generate LMCI 109 for each given segment and each given time epoch. Table 1 below illustrates an example of generating the LMCI 109 by road lane segment and time epoch, according to example embodiment(s).

TABLE 1

| | | | Lane marking |
|---|---|---|---|
| Link ID | Parametric Offset | Time Epoch of Day | Confusion Index |
| 133 | 0 to 0.5 | 9:00 to 9:15 | 0.9 or 90% |
| | | 9:15 to 9:30 | 0.8 or 80% |
| | | 9:30 to 9:45 | 0.7 or 70% |
| | | . . . | . . . |

As shown in Table 1, the index module 305 has calculated the lane marking confusion indexes for each time epoch (e.g., 9:00 to 9:15, 9:15 to 9:30, 9:30 to 9:45, and so on) for a give road lane segment (e.g., identified by Link ID 133 at parametric offset 0 to 0.5).

In one embodiment, the validation module 307 can determine or validate the correct travel lane, the incorrect travel lane, or a combination thereof based on vehicle probe data traveling through the location. For instance, the sensor data 111 can include probe data collected from the one or more devices associated with one or more vehicles 107 and/or UEs 113 traveling on the road lane. The probe data, for instance, is a collection of probes/probe points comprising a probe identifier (e.g., to uniquely identify probes from the vehicles 107 and/or the UEs 113), geolocation (e.g., latitude and longitude determined by a location sensor such as, but not limited to, a satellite-based location receiver, or equivalent), a timestamp, and optionally additional parameters such as, but not limited to, a speed, a brake signal to indicate a status of brake actuation, and/or the like. In this embodiment, the validation module 307 can process the probe data to determine a lane confusion event (e.g., an accident avoidance maneuver) associated with the vehicle 107 at the respective location on the road 205. The validation module 307 can construct a path or trajectory from the individual location data points of the probe points in the probe data by, for instance, arranging all the probe points that are associated with a single probe identifier in chronological order and connecting the probe points to describe a trajectory for the vehicle 107 thereby determine whether a lane confusion event occurred (e.g., based on the trajectory shape(s), pattern(s), etc.).

For example, probe data is collected from vehicles 107 traveling on a road lane 203 of the road 205. The system 100 can reconstruct trajectories from the probe data, to detect deviations of the trajectories from the original lane marking 207a and determine that there were lane confusion event occurring at the locations at and/or near the deviations.

In particular, when vehicles are travelling in areas where lane markings are potentially hard to read or confusing, the validation module 307 can process probe data trajectories from the last hours/minutes to validate the right path/lane to follow, i.e., additional confidence on where to go. In another embodiment, the validation module 307 can combine the probe data validation approach with front facing sensors that observe behaviors of vehicles in front with respect to the multiple lanes (e.g., which lanes do these vehicles seem to follow?). This is especially helpful when all the vehicles are autonomous vehicles. In addition to the front facing sensors, the validation module 307 can combine multiple validation mechanisms (as discussed later) to enhance confidence and/or the LMCI. For instance, when every validation mechanism seems to point at the same fact that the detour lane marking(s) should be followed, the LMCI is increased to a higher value, for example, by multiplying the original IMCI with a number of confirmed validation mechanisms. As another instance, the validation module 307 can assign a different weighting factor to different validation mechanisms, and adjust/modify the IMCI accordingly.

In another embodiment, the validation module 307 can determine or validate the correct travel lane, the incorrect travel lane, or a combination thereof by determining which of one or more detected lane markings intersect with at least one obstacle at a different location, for example, using an electronic horizon. The term “electronic horizon” refers to a collection of roads and intersections leading out from the vehicle's current position, and potential driving paths of the vehicle from the current position. The validation module 307 can use an electronic horizon to continuously provide the vehicle with updated data about paths along roads onto which the vehicle can travel from the vehicle's current position. For instance, the validation module 307 can extend the vehicle's electronic Horizon (eH) in the road lane 203 (e.g., into a road work area) to see if some lane(s) will intersect with obstacles in 50/100 m that may result in incident(s) and determine such lane(s) as incorrect lane(s). Taking FIG. 5C as an example, the old/incorrect lane marking generally intersects with other physical elements further down the road. Hence, when the validation module 307 can determine such obstacles earlier and their relationships to the incorrect lane marking leading thereto, thereby determining the correct/detour lane marking and eliminating the confusion.

In another embodiment, the validation module 307 can determine or validate the correct travel lane, the incorrect travel lane, or a combination thereof based on historical information (e.g., a historical progressing of lane markings based on original equipment manufacturer (OEM) data from vehicle manufacturers, satellite data, etc.) indicating an estimated time progression of the plurality of different lane markings. In some situations, leveraging historical information related to the forming of the lane markings could help clarifying confusing lane markings. For instance, the user can ask the vehicle 107 and/or the system 100: “Which lane marking should I follow here?” The validation module 307 can reply: “Follow this set of longer markings because we know the other shorter markings were used for a road work which has finished two weeks ago yet still visible.” Therefore, the validation module 307 can leverage its prior knowledge of what has previously happened in an area in order to reply to subsequent questions/queries.

As another example, the original lane markings can be evident in a map as previously existing, where the presence of new lane markings can imply that the new markings are the correct ones to use while the previous markings are obsolete. This mechanism can be further refined by leveraging/referencing to construction data from a traffic feed or additional sensor detections, for example, to predict when permanent lane markings are likely to appear. By analogy, GPS probes evolution over time can also be used an indicator/validator of which marking to trust more, as described above.

In another embodiment, the validation module 307 can determine or validate the correct travel lane, the incorrect travel lane, or a combination thereof based tagged data from a transportation authority. For instance, the transportation authority can mark on digital maps (e.g., in the geographic database 125) a lane link as “not to follow temporary lines on that link/lane as it is obsolete yet to be removed this month.”

As mentioned, the index module 305 can use real-time sensor data reports and observed lane confusion events to compute the lane marking confusion index 109 of a given segment by more than a threshold value. In one embodiment, the sensor data 111 is reported in real time.

In one embodiment, in step 405, the output module 309 can store the lane marking confusion index as a map attribute of the location in a geographic database (e.g., the geographic database 125). In another embodiment, the output module 309 can store the lane marking confusion indices as a map layer in the geographic database. For instance, the geographic database 125 uses high-definition map data to facilitate knowing precisely where such road lanes 203 and the individual segments of the lanes are located to make the system 100 more efficient and reliable.

In another embodiment, the output module 309 can transmit a remote monitoring request to at least one vehicle traveling at the location based on determining that the lane marking confusion index is above a threshold value (e.g., 50%). In this case, the remote monitoring request can request that the at least one vehicle report sensor data collected from the location. For instance, when the vehicle 107 reaches an area of uncertainty in terms of lane markings (e.g., LMCI>a threshold), it can trigger a request for remote monitoring and send its video feed in real time to a remote monitoring end point. At the remote monitoring endpoint, a human can assist the vehicle 107 in real time with decision making.

In another embodiment, the output module 309 can use the output of the lane marking confusion index 109 to provide data for generating a mapping user interface that presents a representation of the lane marking confusion index 109 (e.g., by showing some links or portions of links in a highlighted shade or color if their likelihood to have lane confusion events is higher than a threshold value.

In one embodiment, the output module 309 can provide data for generating a warning when approaching the road lane segment based on determining that the lane marking confusion index is greater than a threshold value.

In another embodiment, the output module 309 can provide the lane marking confusion index, the lane confusion event, the location, or a combination thereof as input data for training a machine learning model to predict the lane marking confusion index for other locations.

In another embodiment, the output module 309 can generate an augmented reality user interface indicating the correct travel lane, the incorrect travel lane, or a combination thereof based on determining that the lane marking confusion index is greater than a threshold value. While AR concepts for autonomous vehicle presentation are widely used, leveraging AR in this specific context of lane marking confusion can lead to new interfaces like dedicated AR features that can overlay bright lines over the lane(s) to follow and a different shade overlay over the other detected lanes which are not to follow.

Although various embodiments are described with respect to autonomous vehicles, it is contemplated that the approach described herein may be used with any vehicles with lane keeping assistant.

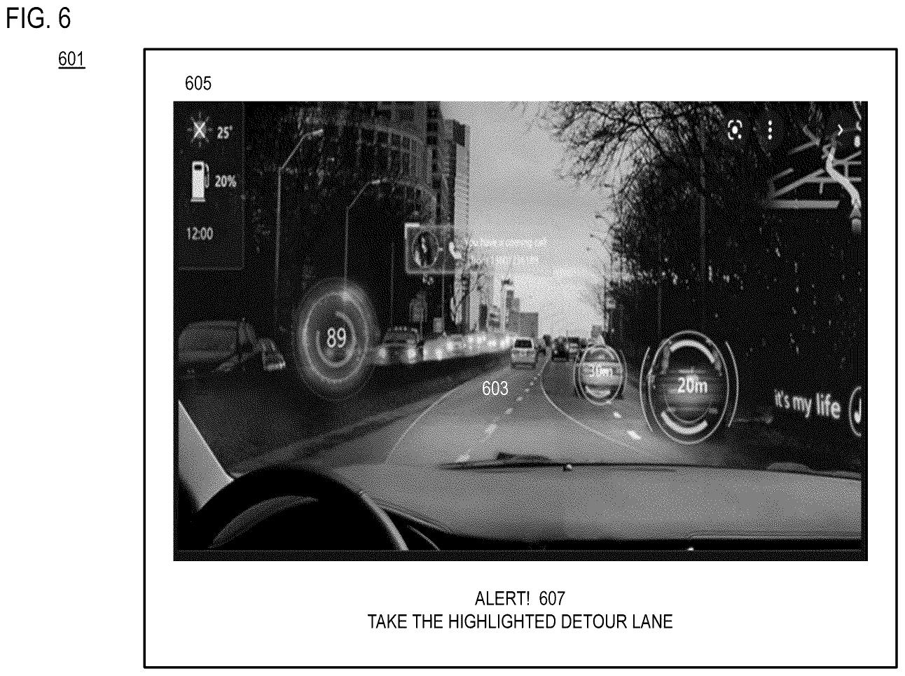

FIG. 6 is a diagram of an example augmented reality (AR) user interface (UI) 601 for navigation routing based on a lane marking confusion index, according to example embodiment(s). In this case, the UI 601 highlights new/detour lane markings of a correct detour lane 603 in a live view 605 for a vehicle (e.g., the vehicle 107) to follow, thereby avoiding keeping in the original lane markings. Concurrently or alternatively, the AR UI 601 can highlight the original lane markings as not to follow, or alert to follow the traffic flow. As in the above-discussed embodiments, the system 100 can determine the new/detour lane markings of the correct detour lane 603 based on a lane marking confusion index 109 (e.g., a number of observed last-minute lane-changing maneuvers), thereby generating alert(s) to reduce likelihood of confusion, such as an alert 607: “Alert! Take the highlighted detour lane.” Other example alerts can include “Staying on the right/normal lane instead of left/temp lane,” “Follow the detour lane for two blocks,” “The detour is scheduled for one month,” etc. If in a self-driving mode, the alert can be “Multiple lane marking detected, and I will follow the left one,” “I saw some faded/old lane marking but not going to follow them,” etc.

It is noted the example use case of the lane marking confusion index 109 described in the various embodiments above are provided by way of illustration and not as limitations.

As described previously, the system 100 can determine a lane marking confusion index based on lane confusion event detections, while lane confusion event(s) can be detected using sensor data collected by camera, LiDAR, location sensors, etc. The vehicles 107, UEs 113, applications 115, and/or any other equivalent device reporting the sensor data 111 could either report: (1) any lane markings on road lanes 203 (e.g., based on image/video or other sensor data 111 geotagged and reported to the cloud—e.g., the mapping platform 121); or (2) lane confusion event(s) based on analysis of the sensor data 111 processed locally on the client device (e.g., the vehicle 107, UE 113, application 115, and/or the like) and/or by the mapping platform 121. The sensor data 111 can be sent to a cloud or server-side component for processing to identify lane confusion event(s) on a road lane, or at the client or edge device (e.g., vehicle 107, UE 113, application 115, etc.) to identify the lane marking(s) and/or lane confusion event(s), and then compute/report the lane marking confusion index (LMCI) to the mapping platform 121. By processing the sensor data 111 and reporting only the LMCI (without the event data), the system 100 can reduce the bandwidth consumption.

In one embodiment, the sensor data 111 includes or is otherwise provided to the sensor data module 301 as a plurality of event and/or LMCI reports associated with a given road lane segment or segments. These reports can include any type of confusing road features including but not limited to the lane markings described above. Some of the confusing road features as illustrated can be time dependent (e.g., recurring road cleaning events) while others are not (e.g., road expansion). In addition, the plurality of reports includes a plurality of real-time reports and/or a plurality of historical reports. The sensor data 111 can be configured to vary the time windows considered to be real-time (e.g., collected with the past 4 hours, 24 hours, week, etc.) versus historical (e.g., all observations of all time, within the past year/6 months/etc.). For example, a shorter real-time or historical data collection period can enable the mapping platform 121 to more quickly respond to changes in the probability of confusing road features and/or confusion events versus longer period where the overall average may be more dominant than individual spikes or changes in the probability.

For example, with respect to sensor data 111 comprising images or image-like data (e.g., LiDAR scans), the processing of the geotagged sensor data 111 comprises using a machine learning model to identify the confusing road features and/or confusion events. In other words, to report or otherwise receive reports of such confusing road features and/or confusion events of the road lane, the system 100 can process sensor data 111 to identify features or objects associated with potential confusing road features and/or confusion events of the road lane. For example, the system 100 can use a machine learning-based feature detection to identify objects such as but not limited to: (1) confusing road features (e.g., confusing lane markings) based on machine learning-based image segmentation; (2) possible confusion events occurring on a road lane (e.g., based on the image data, probe data, historical information, etc. as discussed above). For example, the machine learning model performing the image segmentation can be trained to classify or segment a designated number (n) of the confusing road features and/or confusion events found in road lanes 203. The designated number n can vary depending on a target machine learning model size, available training data, and/or the like.

In one embodiment, if the processing is occurring on the edge device, when the edge device is unsure of confusing road features and/or confusion events, the edge device can send the image (or other sensor data 111) to the cloud (e.g., mapping platform 121) for further help on the classifying/tagging. For example, the mapping platform 121 may have more complex models and/or with more extensive training to provide for higher classification confidence of confusing road features and/or confusion events.

One technique that has shown significant ability to detect potential confusing road features and/or confusion events in images or image-like data is the use of convolutional neural networks (CNN). Neural networks have shown unprecedented ability to recognize objects in images, understand the semantic meaning of images, and segment images according to semantic categories (e.g., object types). An example of a CNN-based feature detector includes, but is not limited to, the You Only Look Once (YOLO) Real Time Object Detection Algorithm or equivalent. The image data (e.g., sensor data 111), for instance, include one or more images of potential confusing road features and/or confusion events at various road lane segments at different times to identify observed confusing road features and/or confusion events. The CNN algorithm is able to train itself on a large database of confusing road features and/or confusion events under different contexts (e.g., different road types, times, weather conditions, lighting conditions, etc.).

In one embodiment, the machine learning system 123 can also perform image segmentation to identify the confusing road features and/or confusion events in an image on a pixel-by-pixel basis. For example, to perform image segmentation, the machine learning system 123 can use a Mask R-CNN or equivalent as an example implementation of image segmentation deep learning network. Mask R-CNN, for instance, enables image segmentation of input images so that individual pixels or groups of pixels of the input image can be classified into semantic categories corresponding instances of the types of confusing road features and/or confusion events. The instance segmentation produces an image mask for each instance of the confusing road features and/or confusion events in a processed image as opposed to a bounding box (e.g., produced using YOLO or faster R-CNN in the various embodiments described above).

In one embodiment, location-based services and/or applications (e.g., provided by the services platform 127, services 129, and/or content providers 131) can use the lane marking confusion index 109 to provide various functions. For example, mapping and/or navigation applications can perform functions including but not limited to: (1) displaying such information on the map; (2) routing vehicles away from the incorrect lane markings which have the highest lane marking confusion index 109; (3) adapt guidance related information; (4) incentivizing public forces (e.g., police) to be present at the most dangerous locations (e.g., to avoid improper lane markings on road lanes); (5) simulate areas for urban planners using such collected data; and/or the like.

Returning to FIG. 1, as shown, the system 100 includes the mapping platform 121 for determining a lane marking confusion index 109 using sensor data 111 (e.g., image data, probe data, etc.). In one embodiment, the mapping platform 121 has connectivity over the communication network 119 to services platform 127 that provides one or more services 129 that can use the lane marking confusion index 109 for downstream functions. By way of example, the services 129 may be third party services and include but is not limited to mapping services, navigation services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services 129 uses the output of the mapping platform 121 (e.g., lane marking confusion index 109, geographic database 125, etc.) to provide services such as navigation, mapping, other location-based services, etc. to the vehicles 107, UEs 113, applications 115, and/or other client devices.

In one embodiment, the mapping platform 121 may be a platform with multiple interconnected components. The mapping platform 121 may include multiple servers, intelligent networking devices, computing devices, components, and corresponding software for determining map feature identification confidence levels for a given user according to the various embodiments described herein. In addition, it is noted that the mapping platform 121 may be a separate entity of the system 100, a part of one or more services 129, a part of the services platform 127, or included within components of the vehicles 107 and/or UEs 113.

In one embodiment, content providers 131 may provide content or data (e.g., including sensor data 111 such as image data, probe data, related geographic data, etc.) to the geographic database 125, machine learning system 123, the mapping platform 121, the services platform 127, the services 129, the vehicles 107, the UEs 113, and/or the applications 115 executing on the UEs 113. The content provided may be any type of content, such as sensor data, imagery, probe data, machine learning models, permutations matrices, map embeddings, map content, textual content, audio content, video content, image content, etc. In one embodiment, the content providers 131 may provide content that may aid in determining the lane marking confusion index 109 according to the various embodiments described herein. In one embodiment, the content providers 131 may also store content associated with the geographic database 125, mapping platform 121, services platform 127, services 129, and/or any other component of the system 100. In another embodiment, the content providers 131 may manage access to a central repository of data, and offer a consistent, standard interface to data, such as a repository of the geographic database 125.

In one embodiment, the vehicles 107 and/or UEs 113 may execute software applications 115 to use lane marking confusion index 109 or other data derived therefrom according to the embodiments described herein. By way of example, the applications 115 may also be any type of application that is executable on the vehicles 107 and/or UEs 113, such as vehicle driving assist applications (e.g., LKA), routing applications, mapping applications, location-based service applications, navigation applications, device control applications, content provisioning services, camera/imaging application, media player applications, social networking applications, calendar applications, and the like. In one embodiment, the applications 115 may act as a client for the mapping platform 121 and perform one or more functions associated with determining the lane marking confusion index 109 alone or in combination with the mapping platform 121.

By way of example, the vehicles 107 and/or UEs 113 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the vehicles 107 and/or UEs 113 can support any type of interface to the user (such as “wearable” circuitry, etc.). In one embodiment, the vehicles 107 and/or UEs 113 may be associated with or be a component of a vehicle or any other device.

In one embodiment, the vehicles 107 and/or UEs 113 are configured with various sensors for generating or collecting sensor data 111 (e.g., image data, probe data), related geographic data, etc. In one embodiment, the sensed data represent sensor data associated with a geographic location or coordinates at which the sensor data was collected, and the polyline or polygonal representations of detected objects of interest derived therefrom to generate the digital map data of the geographic database 125. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the vehicles 107 and/or UEs 113 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the vehicles 107 and/or UEs 113 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the vehicles 107 and/or UEs 113 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 119 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 121, services platform 127, services 129, vehicles 107 and/or UEs 113, and/or content providers 131 communicate with each other and other components of the system 100 using well known, new or still developing protocols. In this context, a protocol includes a set of rules defining how the network nodes within the communication network 119 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

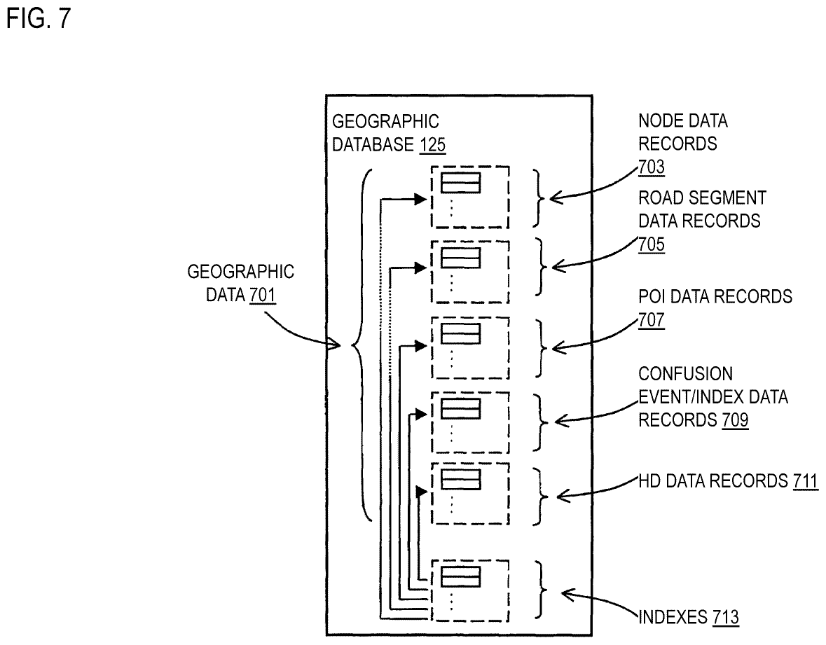

FIG. 7 is a diagram of a geographic database (such as the database 125), according to one embodiment. In one embodiment, the geographic database 125 includes geographic data 701 used for (or configured to be compiled to be used for) mapping and/or navigation-related services, such as for video odometry based on the parametric representation of lanes include, e.g., encoding and/or decoding parametric representations into lane lines. In one embodiment, the geographic database 125 include high resolution or high definition (HD) mapping data that provide centimeter-level or better accuracy of map features. For example, the geographic database 125 can be based on Light Detection and Ranging (LiDAR) or equivalent technology to collect very large numbers of 3D points depedning on the context (e.g., a single street/scene, a country, etc.) and model road surfaces and other map features down to the number lanes and their widths. In one embodiment, the mapping data (e.g., mapping data records 711) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 125.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 125 follows certain conventions. For example, links do not cross themselves and do not cross each other except at a node. Also, there are no duplicated shape points, nodes, or links. Two links that connect each other have a common node. In the geographic database 125, overlapping geographic features are represented by overlapping polygons. When polygons overlap, the boundary of one polygon crosses the boundary of the other polygon. In the geographic database 125, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 125 includes node data records 703, road segment or link data records 705, POI data records 707, confusion event/index data records 709, mapping data records 711, and indexes 713, for example. More, fewer or different data records can be provided. In one embodiment, additional data records (not shown) can include cartographic (“carto”) data records, routing data, and maneuver data. In one embodiment, the indexes 713 may improve the speed of data retrieval operations in the geographic database 125. In one embodiment, the indexes 713 may be used to quickly locate data without having to search every row in the geographic database 125 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points (such as intersections) corresponding to the respective links or segments of the road segment data records 705. The road link data records 705 and the node data records 703 represent a road network, such as used by vehicles, cars, and/or other entities. Alternatively, the geographic database 125 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 125 can include data about the POIs and their respective locations in the POI data records 707. The geographic database 125 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city). In one embodiment, certain attributes, such as lane marking data records, mapping data records and/or other attributes can be features or layers associated with the link-node structure of the database.

In one embodiment, the geographic database 125 can also include confusion event/index data records 709 for storing road feature confusion event/index data, road feature confusion event learning model data, training data, prediction models, annotated observations, computed featured distributions, sampling probabilities, and/or any other data generated or used by the system 100 according to the various embodiments described herein. By way of example, the confusion event/index data records 709 can be associated with one or more of the node records 703, road segment records 705, and/or POI data records 707 to support localization or visual odometry based on the features stored therein and the corresponding estimated quality of the features. In this way, the records 709 can also be associated with or used to classify the characteristics or metadata of the corresponding records 703, 705, and/or 707.

In one embodiment, as discussed above, the mapping data records 711 model road surfaces and other map features to centimeter-level or better accuracy. The mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 711 are divided into spatial partitions of varying sizes to provide mapping data to vehicles 107 and other end user devices with near real-time speed without overloading the available resources of the vehicles 107 and/or devices (e.g., computational, memory, bandwidth, etc. resources).

In one embodiment, the mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 711.

In one embodiment, the mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 125 can be maintained by the content provider 131 in association with the services platform 127 (e.g., a map developer). The map developer can collect geographic data to generate and enhance the geographic database 125. There can be different ways used by the map developer to collect data. These ways can include obtaining data from other sources, such as municipalities or respective geographic authorities. In addition, the map developer can employ field personnel to travel by vehicle (e.g., vehicles 107 and/or UEs 113) along roads throughout the geographic region to observe features and/or record information about them, for example. Also, remote sensing, such as aerial or satellite photography, can be used.

The geographic database 125 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 107 or a UE 113, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for determining a lane marking confusion index based on lane confusion event detections may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

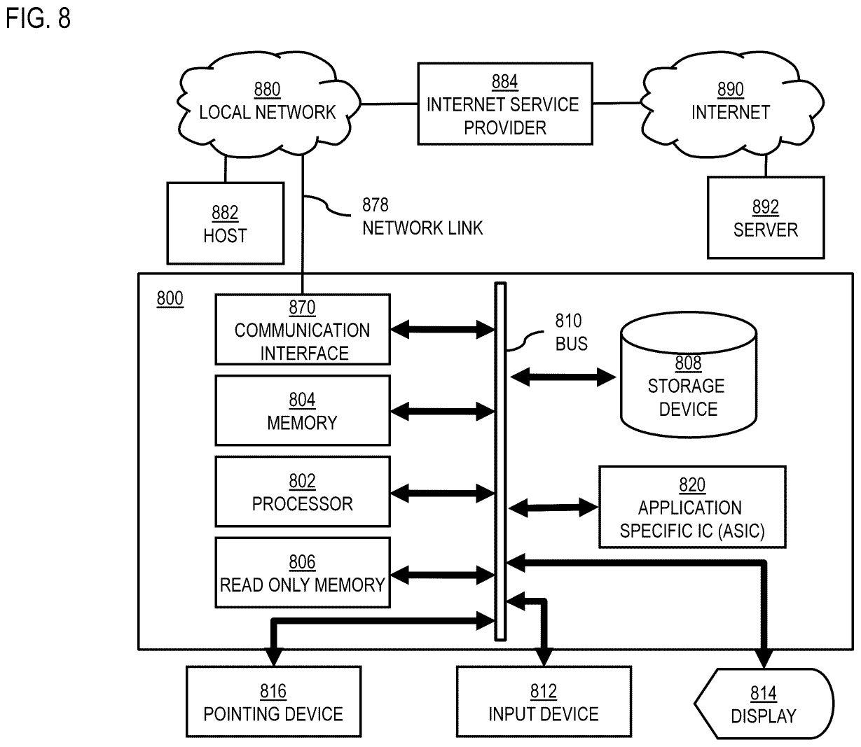

FIG. 8 illustrates a computer system 800 upon which an embodiment of the invention may be implemented. Computer system 800 is programmed (e.g., via computer program code or instructions) to determine a lane marking confusion index based on lane confusion event detections as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to determining a lane marking confusion index based on lane confusion event detections. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RANI) or other dynamic storage device, stores information including processor instructions for determining a lane marking confusion index based on lane confusion event detections. Dynamic memory allows information stored therein to be changed by the computer system 800. RANI allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for determining a lane marking confusion index based on lane confusion event detections, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 119 for determining a lane marking confusion index based on lane confusion event detections.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to determine a lane marking confusion index based on lane confusion event detections as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to determine a lane marking confusion index based on lane confusion event detections. The memory 905 also stores the data associated with or generated by the execution of the inventive steps.

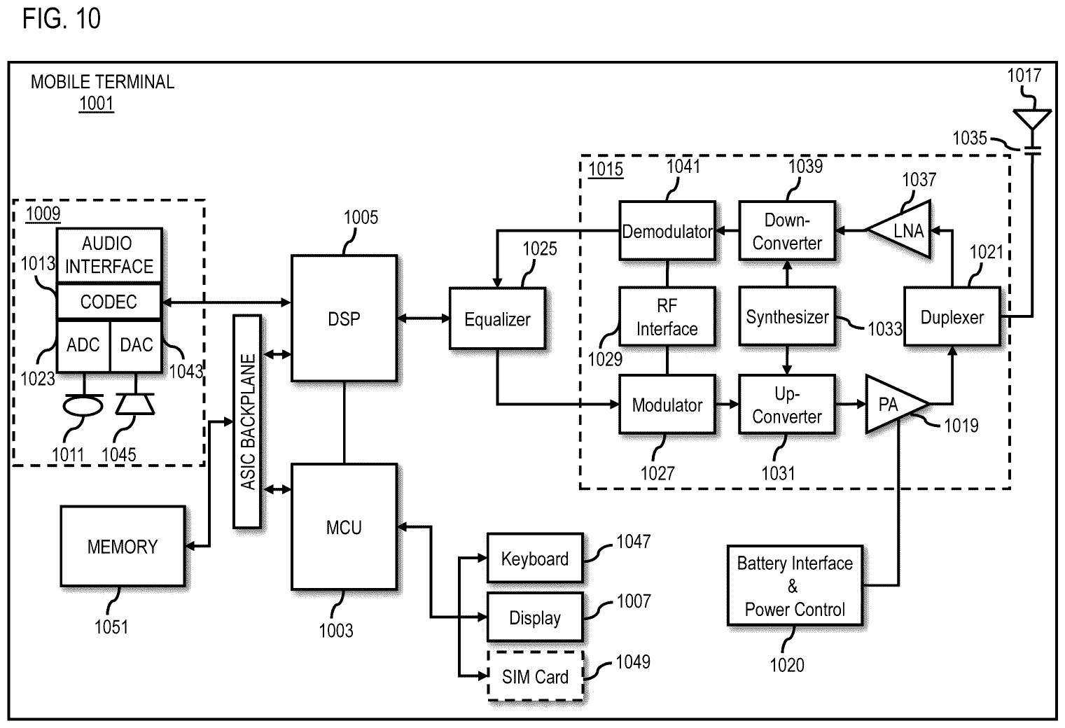

FIG. 10 is a diagram of exemplary components of a mobile terminal 1001 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to determine a lane marking confusion index based on lane confusion event detections. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
detecting, by at least one processor, a number of instances of a lane confusion event associated with a location in a road network, wherein the lane confusion event indicates presence of temporary lane markings in addition to standard lane markings at the location;
determining, by the at least on processor, a lane marking confusion index for the location based on the detected number of instances of the lane confusion event in association with the location; and
storing, by the at least one processor, the lane marking confusion index as a map attribute of the location in a geographic database.

2. The method of claim 1, wherein detecting instances of the lane confusion event comprises obtaining, from one or more vehicles traveling through the location, one or more lane marking reports that each respectively indicates the lane confusion event.

3. The method of claim 2, wherein the one or more lane marking reports indicate a presence of different lane marking colors, a presence of overlapping lane markings, or a combination thereof associated with the lane confusion event at the location.

4. The method of claim 1, wherein the lane confusion event is based on detecting a manual path correction over a lane keeping assist system at the location.

5. The method of claim 1, wherein the lane confusion event indicates a presence of a correct travel lane defined by one of the temporary lane markings and the standard lane markings, and an incorrect travel lane defined by the other one of the temporary lane markings and the standard lane markings at the location.

6. The method of claim 5, wherein the lane confusion event indicates a presence of a construction zone, the correct travel lane defined by the temporary lane markings, and the incorrect travel lane is defined by the standard lane markings at the location.

7. The method of claim 5, wherein the lane confusion event indicates road remarking, the correct travel lane defined by the standard lane markings, and the incorrect travel lane is defined by the temporary lane markings at the location.

8. The method of claim 5, further comprising:
generating an augmented reality user interface indicating the correct travel lane, the incorrect travel lane, or a combination thereof based on determining that the lane marking confusion index is greater than a threshold value.

9. The method of claim 5, further comprising:
determining or validating the correct travel lane, the incorrect travel lane, or a combination thereof based on vehicle probe data traveling through the location.

10. The method of claim 5, further comprising:
determining or validating the correct travel lane, the incorrect travel lane, or a combination thereof by determining which of one or more detected lane markings intersect with at least one obstacle at a different location.

11. The method of claim 5, further comprising:
determining or validating the correct travel lane, the incorrect travel lane, or a combination thereof based on historical information indicating an estimated time progression of the plurality of different lane markings.

12. The method of claim 5, further comprising:
determining or validating the correct travel lane, the incorrect travel lane, or a combination thereof based on tagged data from a transportation authority.

13. The method of claim 1, further comprising:
transmitting a remote monitoring request to at least one vehicle traveling at the location based on determining that the lane marking confusion index is above a threshold value,
wherein the remote monitoring request requests that the at least one vehicle report sensor data collected from the location.

14. The method of claim 1, further comprising:
providing the lane marking confusion index, the lane confusion event, the location, or a combination thereof as input data for training a machine learning model to predict the lane marking confusion index for other locations.

15. An apparatus comprising:
at least one processor; and
at least one memory including computer program code for one or more programs,
the at least one memory and the computer program code configured to, with the at least one processor, cause the apparatus to perform at least the following:
detect a number of instances of a confusion event associated with a road feature occurring at a location in a road network, wherein the confusion event relates to confusion over a correct autonomous maneuver for a vehicle to perform within a threshold proximity of the road feature;
determine a confusion index for the location based on the detected number of instances of the confusion event; and
storing the confusion index as a map attribute of the location in a geographic database.

16. The apparatus of claim 15, wherein the road feature includes a lane marking, a road sign, or a combination thereof.

17. The apparatus of claim 15, wherein detecting instances of the confusion event comprises obtaining from one or more vehicles traveling through the location, one or more road feature reports that each respectively indicates the confusion event at the location.

18. A non-transitory computer-readable storage medium carrying one or more sequences of one or more instructions which, when executed by one or more processors, cause an apparatus to perform:
detecting a number of instances of a lane confusion event associated with a location in a road network, wherein the lane confusion event indicates presence of temporary lane markings in addition to standard lane markings at the location;
determining a lane marking confusion index for the location based on the detected number of instances of the lane confusion event in association with the location; and
storing the lane marking confusion index as a map attribute of the location in a geographic database.

19. The non-transitory computer-readable storage medium of claim 18, wherein detecting instances of the lane confusion event comprises obtaining, from one or more vehicles traveling through the location, one or more lane marking reports that each respectively indicates the lane confusion event.

20. The non-transitory computer-readable storage medium of claim 18, wherein the lane confusion event is based on detecting a manual path correction over a lane keeping assist system at the location.
